(19) United States
(12) Patent Application Publication
(10) Pub. No.: US 2006/0152637 A1
(43) Pub. Date: Jul. 13, 2006

(54) Image display apparatus capable of analog/digital tuning with digital television tuner and analog/digital tuning method thereof

(75) Inventor: Dae-hyun Jang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/203,993

(22) Filed: Aug. 16, 2005

(30) Foreign Application Priority Data
Jan. 7, 2005 (KR) 2005-1846

(51) Int. Cl. H04N 5/50

(52) U.S. Cl. 348/731

(57) ABSTRACT

An image display apparatus capable of analog/digital tuning by a DTV tuner and an analog/digital tuning method thereof are provided. The image display apparatus includes a digital television (DTV) tuner for tuning at least one of an analog signal and a digital signal, a bus switch for switching the DTV tuner to tune at least one of an analog signal and a digital signal, and a control unit for controlling an operation of the bus switch in accordance with at least one mode selected between an analog mode and a digital mode whereby the analog tuning is implemented with a single DTV tuner, so that not only a cost of the analog tuner is reduced but also the design efficiency is increased due to increased space utilization.

### CROSS-REFERENCE TO RELATED APPLICATIONS

This application claims priority from Korean Patent Application No. 2005-1846, filed on Jan. 7, 2005, the entire content of which is incorporated herein by reference.

### BACKGROUND OF THE INVENTION

1. Field of the Invention

The present invention relates to an image display apparatus and an analog/digital tuning method thereof, and more particularly, to an image display apparatus and an analog/digital tuning method thereof, capable of tuning analog and digital signals using a tuner for use solely with a digital television (DTV).

2. Description of the Related Art

An image display apparatus displays an image received from the outside through an antenna, a cable and the like, and an image stored in memory media. As examples, the image display apparatus generally includes a video cassette recorder (VCR), a digital versatile disk (DVD) reproducing apparatus, a compact disk (CD) reproducing apparatus, a hard disk drive (HDD) reproducing apparatus, a camcorder, a digital camera, a mobile phone, a personal digital assistant (PDA), a television (TV), a set top box, and a personal computer (PC).

With the development of DTV broadcasting, there has been a gradual development and spread of TV as one example of an image display apparatus capable of displaying an image with analog and digital mixed broadcasting. In such a manner, the image display apparatus capable of compatibly supporting both analog broadcasting and digital broadcasting is called a built-in DTV. Built-in DTV can provide analog and digital broadcasts received from the outside through an antenna.

However, the image display apparatus of the prior art, capable of providing analog and digital broadcasts, includes two tuners, i.e., an analog tuner for analog broadcasting and a digital tuner for digital broadcasting. Hereinafter, a conventional analog/digital tuning method will be described in detail with reference to FIG. 1 which illustrates a block diagram of the conventional image display apparatus. Referring to FIG. 1, the conventional image display apparatus includes a DTV tuner 110, a DTV signal processing unit 120, an analog tuner 130, a signal processing unit 140, and an audio/video (A/V) switch 150.

The DTV tuner 110 demodulates an intermediate frequency (IF) signal output obtained by detecting and tuning the frequency band of the selected broadcasting channel to thus convert into a transport stream (TS) type digital signal. The DTV signal processing unit 120 decodes and demultiplexes the digital signal to thus encode into an analog type A/V signal. The analog tuner 130 demodulates an intermediate frequency (IF) signal obtained by detecting and tuning the frequency band of the selected broadcasting channel to a composite video banking sync/sound intermediate frequency (CVBS/SIF) type signal. The signal processing unit 140 processes color saturation and sound to thus output an A/V signal. The A/V switch 150 switches the signal of the two output A/V signals that is to be displayed. At this time, the front stage of the DTV tuner 110 and the analog tuner 130 utilizing the same radio frequency (RF) range such as very high frequency (VHF) and ultra high frequency (UHF) is constructed in the same type as phase locked loop (PLL).

Therefore, using the two tuners increases a cost of products reduces design efficiency due to restrictions in space.

### SUMMARY OF THE INVENTION

Accordingly, it is an aspect of the present invention to provide an image display apparatus capable of analog/digital tuning by a DTV tuner providing analog and digital broadcasts by use of a single tuner, and an analog/digital tuning method thereof.

The above aspect of the present invention is substantially realized by providing an image display apparatus comprising: a digital television (DTV) tuner for tuning at least one of an analog signal and a digital signal; a bus switch for switching the DTV tuner to tune at least one of an analog signal and a digital signal; and a control unit for controlling an operation of the bus switch in accordance with at least one mode selected between an analog mode and a digital mode.

In an exemplary embodiment, the bus switch may use an I2C switching method such that if selected the analog mode, switching an analog bus, and if selected the digital mode, switching a digital bus.

In an exemplary embodiment, if a reset mode is selected, the control unit may reset the DTV tuner after receipt of booting completion message from the DTV tuner.

In accordance with another aspect of the present invention, there is provided a method for analog/digital tuning of an image display apparatus, the method comprising: switching for tuning at least one of an analog broadcasting signal and a digital broadcasting signal in accordance with at least one mode selected from an analog mode and a digital mode; and tuning at least one of the analog broadcasting signal and the digital broadcasting signal.

In an exemplary embodiment, the switching may use an I2C switching method such that if the analog mode is selected, switching an analog bus, and if the digital mode is selected, switching a digital bus.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a block diagram of an image display apparatus according to an exemplary embodiment of the prior art;

FIG. 2 is a block diagram of an image display apparatus according to an exemplary embodiment of the present invention;

FIG. 3 is a block diagram of an image display apparatus according to another exemplary embodiment of the present invention; and

FIG. 4 is a flowchart illustrating a method for analog/digital tuning of an image display apparatus according to an exemplary embodiment of the present invention.

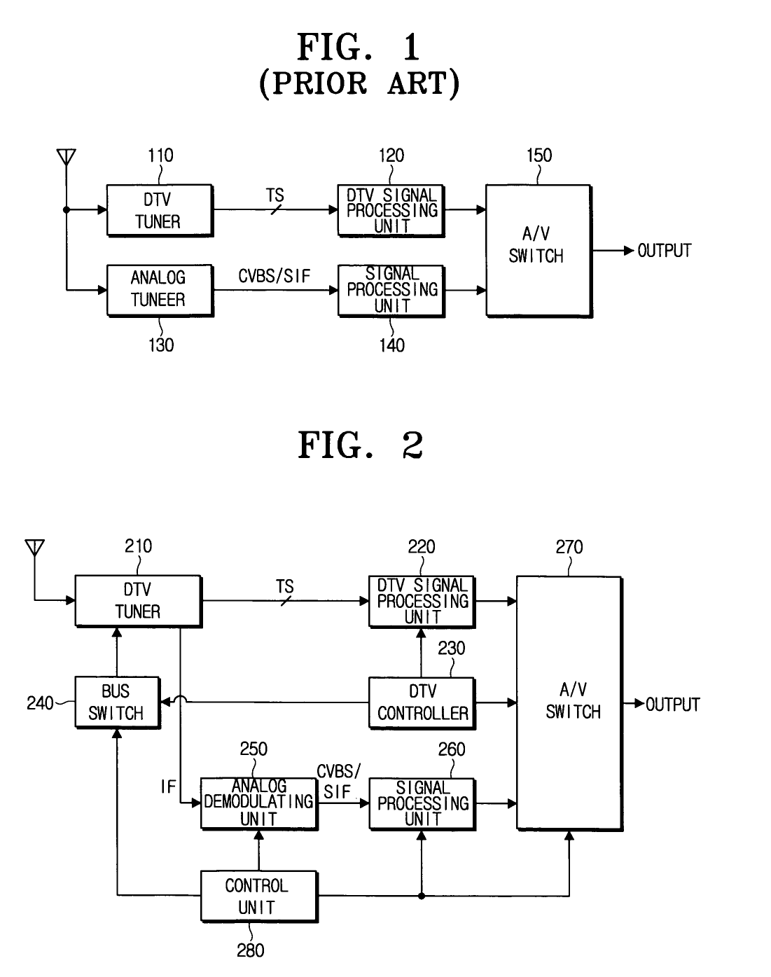

### DETAILED DESCRIPTION OF THE EXEMPLARY EMBODIMENTS

Hereinafter, the exemplary embodiments of the present invention will be described in detail with reference to the drawings.

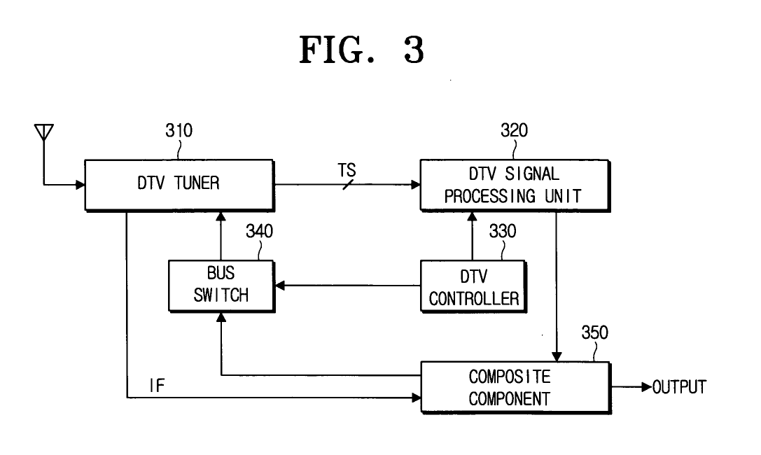

FIG. 2 is a block diagram of an image display apparatus according to an exemplary embodiment of the present invention.

Referring to FIG. 2, the image display apparatus of the present invention includes a digital television (DTV) tuner 210, a DTV signal processing unit 220, a DTV controller 230, a bus switch 240, an analog demodulating unit 250, a signal processing unit 260, an audio/video (A/V) switch 270 and a control unit 280.

The DTV tuner 210 utilizes an orthogonal frequency division multiplexing (OFDM) method and a network interface module (NIM). A front stage of the DTV tuner is constructed with a phase locked loop (PLL) to thus secure both an analog mode and a digital mode.

If the digital mode is selected, the DTV tuner 210 station-selects a digital broadcasting channel selected by a user from the signals received through an antenna. The DTV tuner 210 digitalizes the broadcasting signals of the selected broadcasting channel. At this time, the DTV tuner 210 detects and tunes a frequency band of the selected broadcasting channel thereby outputting an IF signal. The DTV tuner 210 includes a demodulator (not shown) to convert and output the IF signal into a TS type digital signal. The digital mode is to digitalize the broadcasting signal of the selected digital broadcasting channel.

On the other hand, if the analog mode is selected, the DTV tuner 210 station-selects an analog broadcasting channel selected by a user from the signals received through an antenna. The DTV tuner 210 analogizes the broadcasting signals of the selected broadcasting channel. More specifically, the DTV tuner 210 detects and tunes a frequency band of the selected analog broadcasting channel thereby outputting an IF signal. The analog mode is to implement the broadcasting signal of the selected analog broadcasting channel in analog type.

The DTV signal processing unit 220 processes the TS type digital signal converted by the DTV tuner 210 as to allow the user to view. Specifically, the DTV signal processing unit 220 converts and outputs the digital signal into the analog signal (Y, Pb, Pr/CVBS/Audio Lt, Rt) through a decoding, a multiplexing and an encoding.

The DTV controller 230 serves to implement a digitization by controlling the DTV tuner 210 through a digital bus if the digital mode is selected and a bus switch 240 (will be described hereafter) switches a digital I2C. The DTV controller 230 controls the DTV signal processing unit 220 to convert the digital signal into the analog signal.

The bus switch 240 switches between any one of a digital bus control and an analog bus control in an I2C (I square control or Inter IC control; IIC) switching method in accordance with a mode selected by the user. If the analog mode is selected, the bus switch 240 switches to an analog I2C. When the bus switch 240 switches to the analog I2C, the control unit 280 controls the DTV tuner 210 through an analog bus. If the digital mode is selected, the bus switch 240 switches to a digital I2C. When the bus switch 240 switches to the digital I2C, the DTV controller 230 controls the DTV tuner 210 through a digital bus.

The analog demodulating unit 250 demodulates an IF signal output by the DTV tuner 210 upon the selection of the analog mode to thus output it as a CVBS/SIF type signal. The analog demodulating unit 250 is separately provided because it is different from the demodulator provided in the DTV tuner 210 in its structure and operation.

The signal processing unit 260 processes the CVBS/SIF type signal output by the analog demodulating unit 250 such that the user can view it. Specifically, the signal processing unit 260 processes a saturation adjustment to CVBS to output it in RGB (red, green, blue) type, and demodulates SIF to output it as an analog audio signal.

The A/V switch 270 switches in accordance with the mode selected by the user, to a certain A/V signal to be displayed between an A/V signal output from the DTV signal processing unit 220 and an A/V signal output from the signal processing unit 260.

Since all the displayed A/V signals are the analog signals, the control unit 280 has priority over the DTV controller 230. Thus, the controller 280 controls the bus switch 240 in accordance with the mode selection of the user. When the analog mode is selected, the control unit 280 controls the bus switch 240 to switch to the analog I2C. When the digital mode is selected, the control unit 280 controls the bus switch 240 to switch to the digital I2C.

When the analog mode is selected and the bus switch 240 switches to the analog I2C, the control unit 280 controls the DTV tuner 210 through the analog bus to have an analog signal. The control unit 280 controls the analog demodulating unit 250 to demodulate the IF signal output by the DTV tuner 210 to thus output the CVBS/SIF type signal. Further, the control unit 280 controls the signal processing unit 260 to process the CVBS/SIF type signal output by the analog demodulating unit 250 such that the user can view it.

Furthermore, the control unit 280 controls the A/V switch 270 in accordance with the mode selected by the user. When the analog mode is selected, the control unit 280 controls the A/V switch 270 to output the A/V signal output by the signal processing unit 260. When the digital mode is selected, the control unit 280 controls the A/V switch 270 to output the A/V signal output by the DTV signal processing unit 220.

FIG. 3 is a block diagram of an image display apparatus according to another exemplary embodiment of the present invention.

Referring to FIG. 3, the image display apparatus includes a DTV tuner 310, a DTV signal processing unit 320, a DTV controller 330, a bus switch 340, and a composite component 350. The DTV tuner 310, the DTV signal processing unit 320, the DTV controller 330, and the bus switch 340 are the same as those elements 210, 220, 230 and 240 illustrated in and explained above with reference to FIG. 2, so that the explanation thereof shall be omitted.

The composite component 350 is integrated into one chip that includes the analog demodulating unit 250, the signal processing unit 260, the audio/video (A/V) switch 270 and the control unit 280 as illustrated in FIG. 2, and which is operated as explained in FIG. 2. The construction of one chip type composite component 350 makes it possible to improve a design efficiency and thus to increase a space utilization.

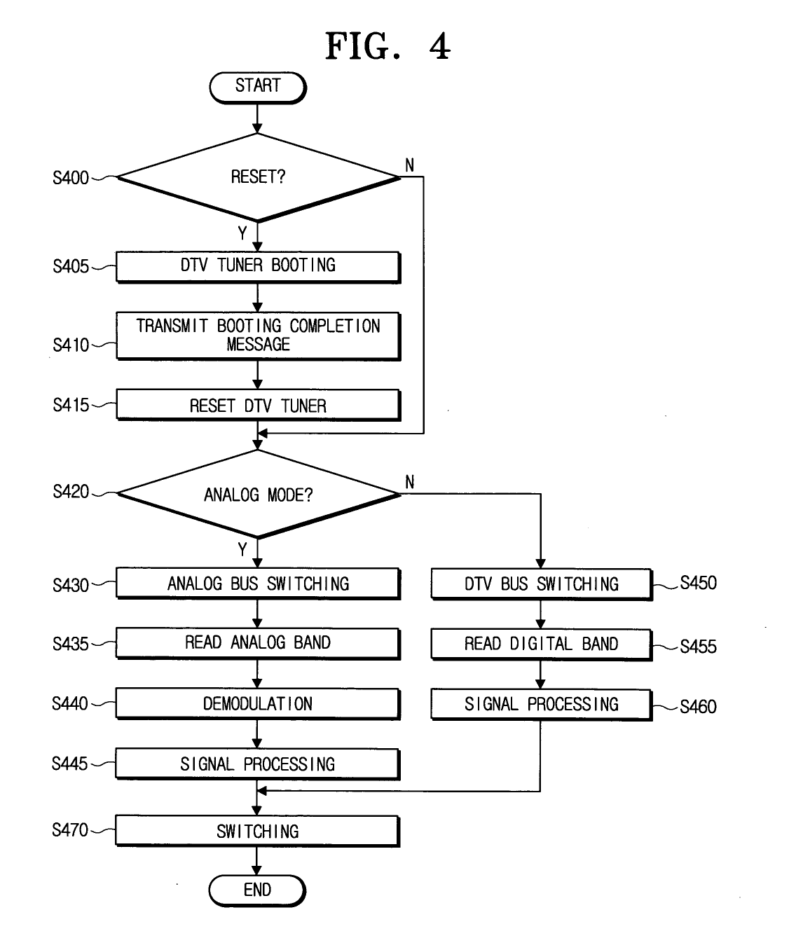

FIG. 4 is a flowchart illustrating a method for analog/digital tuning of an image display apparatus according to an exemplary embodiment of the present invention.

Referring to FIG. 4, the control unit 280 determines whether a reset mode is selected by the user (S400). The reset mode is to initialize the DTV tuner 210.

When the reset mode is selected, the DTV tuner 210 implements a booting (S405). The DTV tuner 210 establishes an initial environment during the booting.

When the booting is completed, the DTV tuner 210 transmits a booting completion message to the control unit 280 (S410).

The DTV tuner 210 implements a resetting under the control of the control unit 280 (S415). When the booting completion message is transmitted by the DTV tuner 210, the control unit 280 controls the DTV tuner 210 to implement the resetting.

The control unit 280 determines whether the analog mode is selected by the user (S420). The analog mode is to have the broadcasting signal of the selected analog broadcasting channel in an analog form.

When the analog mode is selected, the bus switch 240 switches the analog bus (S430). If it is determined that the analog mode is selected, the control unit 280 controls the bus switch 240 to switch to the analog I2C.

The DTV tuner 210 reads the analog band (S435). Specifically, when the analog I2C is switched, the control unit 280 controls the DTV tuner 210 to detect and tune the frequency band of the station-selected analog broadcasting channel to output an IF signal.

The analog demodulating unit 250 demodulates, under the control of the control unit 280, the IF signal output by the DTV tuner 210 to output a CVBS/SIF type signal (S440).

The signal processing unit 260 processes the CVBS/SIF type signal output by the analog demodulating unit 250 such that the user can view it (S445). To be specific, the signal processing unit 260 processes CVBS to have the saturation adjustment to thus output it in RGB type, and demodulates SIF to output it in analog audio type, with the control of the control unit 280.

In the operation S420, when the digital mode is selected, the bus switch 240 switches the digital bus (S450). If it is determined that the digital mode is selected, the control unit 280 controls the bus switch 240 to switch to the digital I2C. The digital mode is to digitalize the broadcasting signal of the selected digital broadcasting channel.

The DTV tuner 210 reads the digital band (S455). Specifically, when the bus switch 240 switches to the digital I2C, the DTV controller 230 controls the DTV tuner 210 to detect and tune the frequency band of the station-selected broadcasting channel to output an IF signal. The DTV tuner 210 converts the IF signal with the control of the DTV controller 230 into a TS type digital signal, using the demodulator provided thereto.

The DTV signal processing unit 220 processes the TS type digital signal converted by the DTV tuner 210 as to allow the user to view (S460). Specifically, the DTV signal processing unit 220 converts and outputs, under the control of the DTV controller 230, the digital signal into the analog signal (Y, Pb, Pr/CVBS/Audio Lt, Rt) through a decoding, a demuxing and an encoding.

The A/V switch 270 switches in accordance with the mode selected by the user to a certain A/V signal to be displayed between an A/V signal output from the DTV signal processing unit 220 and an A/V signal output from the signal processing unit 260 (S470). In the step S420, when the analog mode is selected, the control unit 280 controls the A/V switch 270 to output the A/V signal output by the signal processing unit 260. In the step S420, when selected the digital mode, the control unit 280 controls the A/V switch 270 to output the A/V signal output by the DTV signal processing unit 220.

As described above, in accordance with the present invention, the analog broadcasting is implemented with a single DTV tuner, so that not only a cost of the analog tuner is reduced but also the design efficiency is improved to thus increase space utilization. Since a coaxial cable for connecting two tuners is not required, there is little signal interference or attenuation and a manufacturing cost is reduced.

The foregoing embodiments and aspects are merely exemplary and are not to be construed as limiting the present invention. The present teaching can be readily applied to other types of apparatuses. The description of the embodiments of the present invention is intended to be exemplary and not to limit the scope of the claims, and many alternatives, modifications, and variations will be apparent to those skilled in the art.

What is claimed is:

1. An image display apparatus comprising:
a digital television (DTV) tuner which tunes at least one of an analog signal and a digital signal;
a bus switch which switches the DTV tuner to tune the at least one of the analog signal and the digital signal; and
a control unit which controls an operation of the bus switch in accordance with at least one mode selected between an analog mode and a digital mode.

2. The image display apparatus as claimed in claim 1, wherein the bus switch uses an I-squared-C (I2C) switching method such that if the analog mode is selected, the bus switch switches to an analog bus, and if the digital mode is selected, the bus switch switches to a digital bus.

3. The image display apparatus as claimed in claim 1, wherein if a reset mode is selected, the control unit resets the DTV tuner in response to receipt of a booting completion message from the DTV tuner.

4. A method for analog/digital tuning of an image display apparatus, the method comprising:
switching for tuning at least one of an analog broadcasting signal and a digital broadcasting signal in accordance with at least one mode selected from an analog mode and a digital mode; and
tuning at least one of the analog broadcasting signal and the digital broadcasting signal.

5. The method as claimed in claim 4, wherein the switching for tuning uses an I-squared-C (I2C) switching method such that if the analog mode is selected, the switching for tuning comprises switching to an analog bus, and if the digital mode is selected, the switching for tuning comprises switching to a digital bus.

6. The image display apparatus as claimed in claim 1, wherein the DTV tuner is operable to tune the analog signal and the digital signal.

7. The image display apparatus as claimed in claim 6, wherein the DTV tuner outputs an intermediate frequency signal if the DTV tuner tunes the analog signal and outputs a transport stream signal if the DTV tuner tunes the digital signal.
